(19) United States
(12) Patent Application Publication
(10) Pub. No.: US 2006/0158377 A1
(43) Pub. Date: Jul. 20, 2006

(54) Micro chip antenna

(75) Inventors: Chuan-Ling Hu, Taipei Hsien (TW); Meng-Chiu Pan, Taipei Hsien (TW); Shun-Tian Lin, Taipei (TW); Chang-Fa Yang, Taipei (TW); Kuo-Chung Cheng, Taipei (TW); Sea-Fue Wang, Taipei (TW); Lisen Chang, Taipei (TW); Chang-Lun Liao, Taipei (TW); Chia-Hung Chen, Taipei (TW)

Correspondence Address: BACON & THOMAS, PLLC, 625 SLATERS LANE, FOURTH FLOOR, ALEXANDRIA, VA, 22314, US

(73) Assignee: CHANT SINCERE CO., LTD., Taipei Hsien (TW)

(21) Appl. No.: 11/036,015

(22) Filed: Jan. 18, 2005

(51) Int. Cl. H01Q 1/38

(52) U.S. Cl. 343/700 MS; 343/702

(57) ABSTRACT

A method for manufacturing microchip antenna comprises a dielectric substrate having antennal radiated conductor paths composing of a single-feeding end or multiple-feeding ends and multiple-curved paths; a dielectric substrate having the antennal radiated conductor paths being packaged by the material capable of adjusting easily dielectric constant; and an antennal object including antennal radiated conductor paths, feeding ends, welding spots and packaging materials. The main body of the antenna has multi-folded paths, feeding ends, welding spots, and a packaging body. The radiation wires of the antenna is built on a single or a multiple input ends on a dielectric substrate and is multi-folded wires and it is packaged by another dielectric material. The radiation wires of the antenna can be designed and manufactured in three dimension so as to reduce the area occupied by the antenna and reduce the coupling interference between the elements.

### FIELD OF THE INVENTION

The present invention relates to micro ship antenna, and in particular to a method for manufacturing a microchip antenna. The main body of the antenna includes multi-folded paths, feeding ends, welding spots, and a packaging body. The radiation wires of the antenna is built on a single or multiple inputs on a dielectric substrate and is multi-folded wires. It is packaged by another dielectric material. The radiation wires of the antenna can be designed and manufactured in three dimensions so as to reduce the area occupied by the antenna and reduce the coupling interference between the elements. Thereby the dielectric constant of the packaging material can be changed to increase the degree of freedom in the design and application of the antenna. Thereby antenna can be design to have multiple frequency bands, be wideband and have an improved radiation pattern.

### BACKGROUND OF THE INVENTION

Wireless transmission is more and more popular due to the unlimited applications of the wireless technology. It is widely used in many fields, such as satellite communication, handset communication, or wireless networks. All these facilities apply technique of wireless transmission. However in wireless communication, antenna is an important element, which is used in electromagnetic wave transmission and receiving. Since an antenna is like a liaison among the wireless products. Antennas are supposed to be a key component for its widespread business usage in the future. In order to reduce the cost of manufacture and fit the design criteria, such as small size, light weight, thin or short sizes, how to design and manufacture antenna becomes an important issue.

Chip antennas are a kind of antenna type and are developed recently. This type of antenna packages metal conductor into dielectric material. As far as we know, if electromagnetic wave spreads in the material having higher dielectric constant, then the wave speed will slow down for the sake of material property and the wavelength becomes shorter. The size of antenna will depend on its wavelength. If the wavelength is longer, then the size of antenna will become larger. On the other hand, if the wavelength is shorter, then the size of antenna can be smaller. If the dielectric constant of packaging material is higher, then the whole volume of antenna can be smaller. Almost all products of wireless transformation tend to a trend of compactness, so the invention of chip antenna is very useful for the future development of wireless transformation.

As the prior art techniques is presented in Taiwan Patent No. 480773 The type of antenna starts the stage of three-dimensional structure and apply the technique of low temperature co-combustion (LTTC). However, the manufacturing process of LTTC is very complicated and expensive. In the manufacturing process of LTTC, radiated conductor paths use conductive material plane-printing technology on a ceramic substrate, and then on its adjacent two layers of substrates. Corresponding wire ends form through holes to connect each other. To fill the passing through hole with conductive material to connect the two layers of circuits, this process can build up a three-D structure. Finally, sintering the antenna uses the mean of LTTC ( about 800° C.˜900° C.) and composes it into a single unit. Manufacturing process of LTTC limits the choice of conductive circuit and dielectric material. Besides, it also has the problem of sintering contraction and deformation of conductive wires. Because of the disadvantages of LTTC, such as more complex manufacturing process, huger amount of investing cost and lower degree of freedom for antenna designing, those disadvantages leads to increasing the time of preparation for exploiting new products and the increasing cost in research and development. Therefore, LTTC is not qualified to be an efficiency and suitable manufacturing process.

Another example of prior art is presented in Taiwan Patent No. 518801, “chip antenna and method of manufacturing process thereof”. The invention presents a method for packaging partly metal sheet of conductive loop of an antenna by conductive material, then using residue of the loop to follow the surface of the packaged dielectric material for curving. The invention can reduce the measure of area on the substance of antenna. However, the manufacturing process of the antenna is quite complicated and it is difficulty to control the function of antenna.

Besides, another one example of the prior art is presented in the invention of U.S. Pat. No. 6,636,180. The invention presents a type of printing circuit antenna. The kind of micro-strip antenna includes a printed circuit board, metal chips and multiple curved circuits. The metal chips services as grounded surface. On the top and bottom of printed circuit board has conductive circuits and uses through holes to connect therewith so as to form continuous conductive framework, in order to reduce the size of the antenna, but the conductor loop of the antenna is exposed to user's environment. According to the change of user's nearby environment, the residue of the loop central frequency may increase and has different variations.

Above-mentioned prior arts can only produce specific antenna used in particular frequencies. Applying those methods to antenna often has different degree of shifts to the center frequency due to the displacement of the antenna. In the 2.45 GHz of central frequency, the shift can be 200 MHz. If try to calibrate the shift by modifying the antenna loop, that will be complicated and be a huge work. Therefore, the central frequency usually is adjusted by adding capacitor and inductor to the exterior circuits. The solution will increase producing cost and reduce the measure of PC board. Besides, the degree of freedom to apply antenna will reduce.

### BRIEF DESCRIPTION OF THE DRAWINGS

FIG. 1 is a cross-sectional view for the first embodiment of the invention.

FIG. 2 is perspective view of he first embodiment of the invention.

FIG. 3 is a cross-sectional view for the second embodiment of the invention.

FIG. 4 is perspective view of he second embodiment of the invention.

FIG. 5 is a cross-sectional view for the third embodiment of the invention.

FIG. 6 is perspective view of he third embodiment of the invention.

FIG. 7 is a cross-sectional view for the forth embodiment of the invention.

FIG. 8 is perspective view of he forth embodiment of the invention.

### SUMMARY OF THE INVENTION

The primary objective of the present invention is to provide a method for manufacturing microchip antenna comprises a dielectric substrate having antennal radiated conductor paths composing of a single-feeding end or multiple-feeding ends and multiple-curved paths; a dielectric substrate having the antennal radiated conductor paths being packaged by the material capable of adjusting easily dielectric constant; and an antennal object including antennal radiated conductor paths, feeding ends, welding spots and packaging materials.

Furthermore, the resin-ceramic compound material capable of fine-adjusting the dielectric constant thereof easily is processed into thermal plastic high molecular materials, or thermal setting high molecular materials, and ceramic powders or fiber with various components and ratios; the dielectric constant is adjusted by adjusting the components and ratios.

The conductor loop is processed by the ways of exposure, development, etching, electroplating, non-electroplate, screen printing sintering, sputtering or printing so as to establish the conductor loop on a dielectric substrate with a specific dielectric constant. The dielectric substrate with the conductor paths is packaged by embedding type injection molding, two-material injection molding, mold-filling, screen thick firm printing, transfer printing or stacking so as to package dielectric material to a dielectric substrate with conductor paths.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

The present invention is related to a method for manufacturing a microchip antenna. The method applies a simulation software to establish a simulating framework of a microchip antenna. Then the conductor loop is processed by the ways of exposure, development, etching, electroplating, non-electroplate, screen printing sintering, sputtering or printing so as to establish the conductor loop on a dielectric substrate with a specific dielectric constant. The dielectric constant of dielectric substrate can be defined between 2 to 30. Besides, the dielectric substrate can be one of a printed circuit board, a plastic board, a resin board, a resin-ceramic compound board, a ceramic board or a wafer according to actual needs of manufacturers. By using the dielectric substrate, the resin-ceramic compound board or plastic board with a specific dielectric constant is packaged into dielectric substrates with conductor paths thereon. That uses the techniques of embedding type injection molding, two-material injection molding, mold-filling, screen thick firm printing, transfer printing or stacking to form the micro-antenna finally. The dielectric constant of packaging material is changed slightly by the ways of adjusting antenna of reflection lose and central frequency.

The resin of the above-mentioned resin-ceramic compound board is one of a thermal plastic high molecular material or a thermal setting high molecular material. The dielectric substrate may be a single-layer substrate or a multi-layers substrate with the same or different dielectric constants.

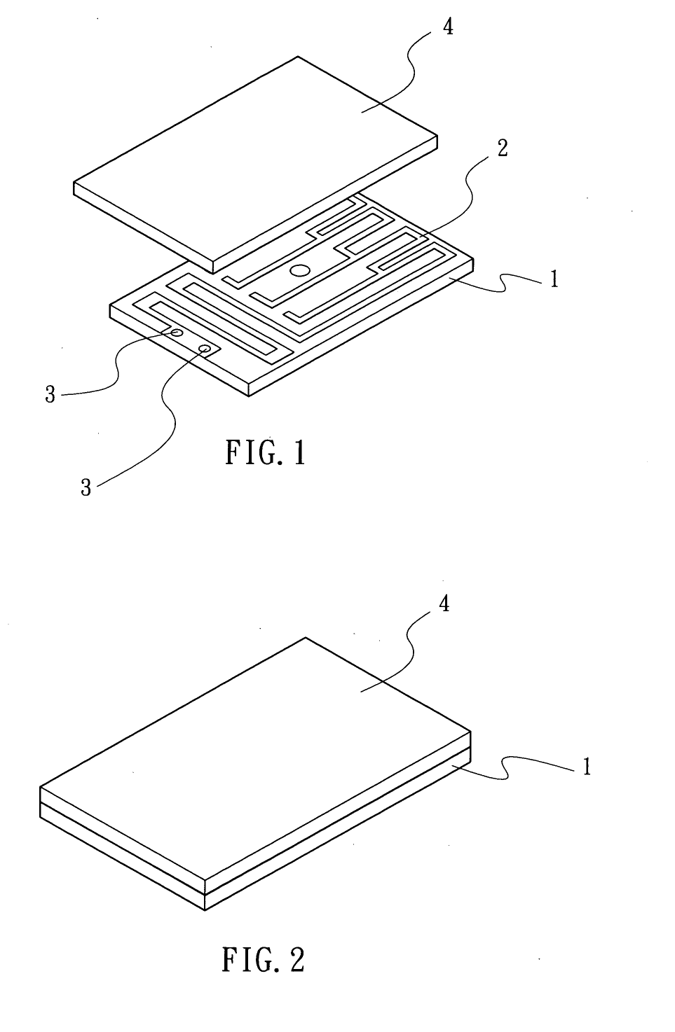

Referencing to FIGS. 1 and 2, the invention is based on a dielectric substrate 1, forming by a printed circuit board, a resin board, a resin-ceramic compound board, a ceramic board or a wafer. The conductor loop 2 is established by various composing methods, such as exposure, development, etching, electroplating or non-electroplating. The conductor loop 2 contains one welding spot 3 which passes through the dielectric substrate 1 to the other welding spot 3 on the other side of dielectric substrate 1. The alternative way is to drill holes in the dielectric substrate 1 and construct the extending conductor loop for increasing the length of the conductor. Then, the resin-ceramic compound board 4 capable of fine-adjusting the dielectric constant thereof easily is packaged as a conductor loop by using the techniques of injection molding, mold-filling, thick firm printing, screen printing, transfer printing or stacking. The dielectric constant of resin-ceramic compound board 4 capable of fine-adjusting the dielectric constant thereof easily is changed by the ways of adjusting the central frequency of the reflection lose of the antenna.

The above-mentioned resin-ceramic compound board 4 capable of fine-adjusting the dielectric constant thereof easily is processed into thermal plastic high molecular materials, or thermal setting high molecular materials, and ceramic powders or fiber with various components and ratios. The dielectric constant is adjusted by adjusting the components and ratios

Referencing to Table. 1 and 2, two types of antenna are presented to show different influences for their various designs of applying environment and antennal reflection lose for changing dielectric constant in the central frequency of resin-ceramic compound board.

Tables 1 and 2 illustrate that it is unnecessary to change the framework of the lower substrate 1 of the antenna and the conductor loop 2, while it is only necessary to change the component (or dielectric constant) of packaging material 4 (e.g. resin-ceramic compound board), then the unique microchip antenna can be produced.

TABLE 1

| Dielectric constant of | | Central | |
|---|---|---|---|
| resin-ceramic | Environment of nearby | Frequency | Bandwidth |
| compound board | antenna | (GHz) | (MHz) |
| 5.0 | air | 2.31 | 200 |
| 5.0 | Casing of net wires and | 2.18 | 180 |
| | net cards | | |
| 4.0 | air | 2.46 | 220 |
| 4.0 | Casing of net wires and | 2.34 | 190 |
| | net cards | | |
| 3.7 | Air | 2.53 | 220 |
| 3.7 | Casing of net wires and | 2.41 | 200 |
| | net cards | | |

TABLE 2

| Dielectric constant of | | Central | |
|---|---|---|---|
| resin-ceramic | Environment of nearby | Frequency | Bandwidth |
| compound board | antenna | (GHz) | (MHz) |
| 27 | Air | 2.40 | 160 |
| 27 | Casing of net wires and | 2.34 | 160 |
| | net cards | | |
| 26 | Air | 2.45 | 180 |
| 26 | Casing of net wires and | 2.38 | 170 |
| | net cards | | |
| 25 | Air | 2.54 | 180 |
| 25 | Casing of net wires and | 2.46 | 170 |
| | net cards | | |

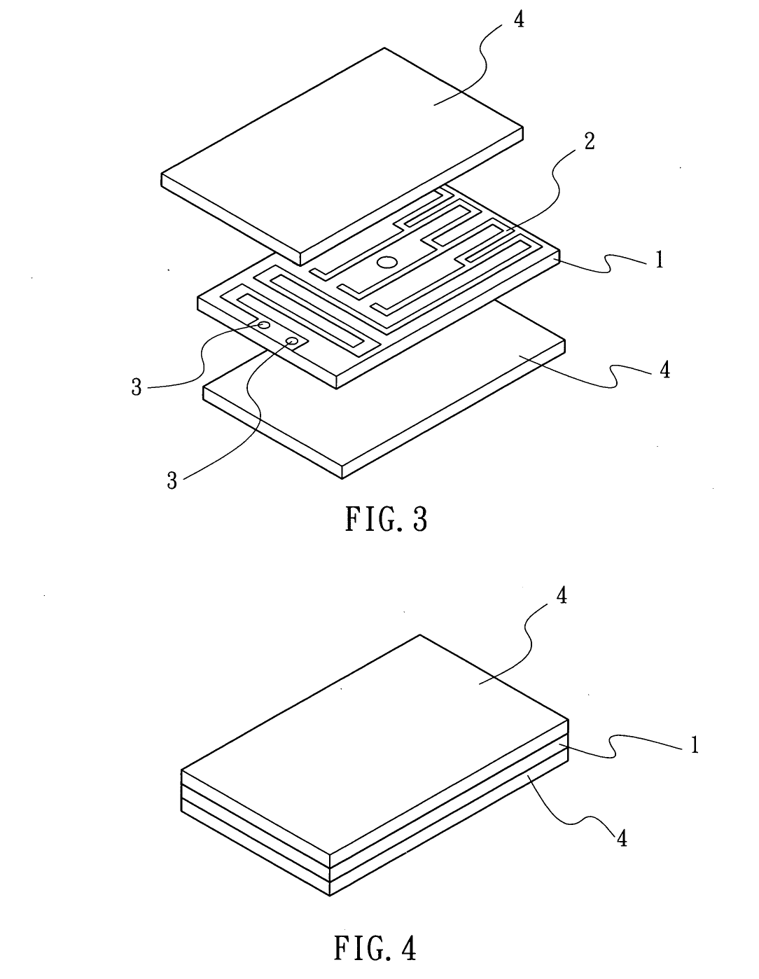

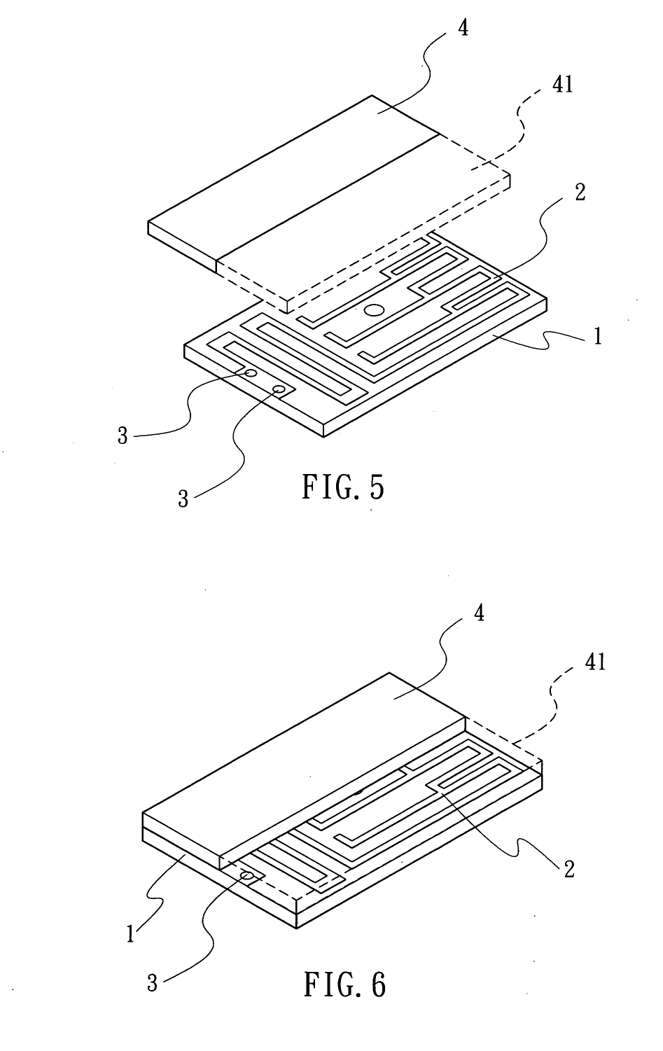

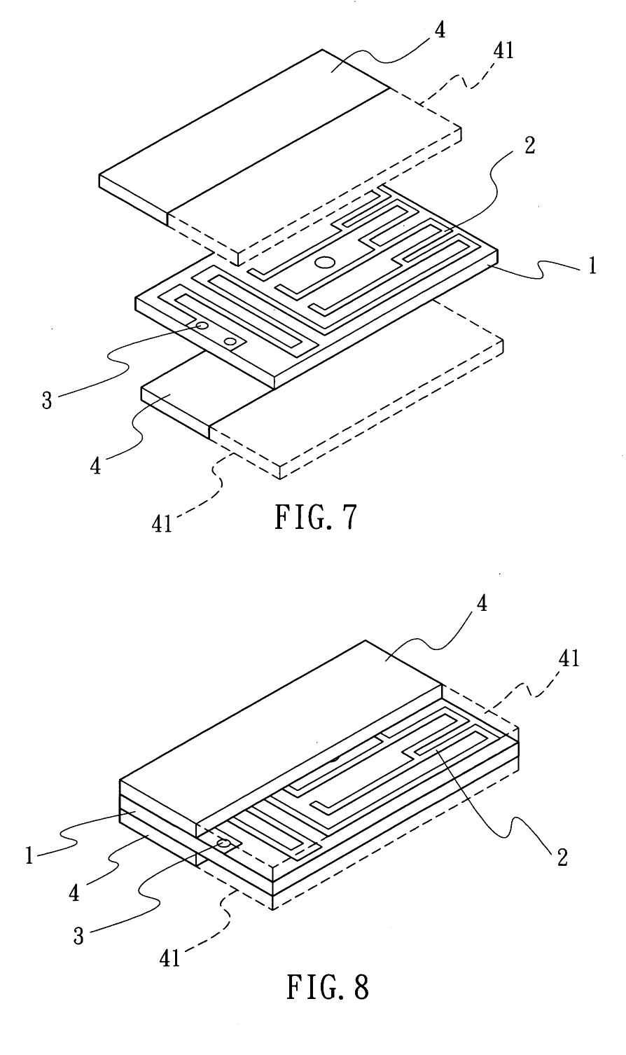

The packaging material 4 and the dielectric substrate 1 having antennal radiated conductor paths can be packaged by the ways of single surface packaging, or by double surface packaging as illustrated in FIGS. 3 and 4. Or as illustrated in FIGS. 5 and 6, the invention also can be packaged by the way of partial single surface packaging. Or as illustrated in FIGS. 7 and 8, it can be packaged by the way of partial double surface packaging.

In the above-mentioned single surface or double surface packaging, the size of packaging material can be a partial section of the lower substrate 1, and the other part of the substrate 1 is uncovered (or fill by air). So the surface package can combine with any non-packaging material 4 to be the component (e.g. the other partial section can be another material, which is different form packaging material 4)

In other words, the above-mentioned packaging material 4 can be composed by two or more different materials. To sum up, the invention proposes the method for manufacturing microchip antenna, and the method is a creative and progressive design undoubtedly.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claim is:

1. A method for manufacturing microchip antenna comprising:
a dielectric substrate having antennal radiated conductor paths composing of a single-feeding end or multiple-feeding ends and multiple-curved paths;
a dielectric substrate having the antennal radiated conductor paths being packaged by the material capable of adjusting easily dielectric constant; and
an antennal object including antennal radiated conductor paths, feeding ends, welding spots and packaging materials.

2. The method for manufacturing microchip antenna as claimed in claim 1, wherein the material capable of adjusting easily dielectric constant is one of a resin-ceramic compound board and a plastic board.

3. The method for manufacturing microchip antenna as claimed in claim 1, wherein the dielectric substrate is one of a printed circuit board, a plastic board, a resin-ceramic compound board, a ceramic board and a wafer.

4. The method for manufacturing microchip antenna as claimed in claim 3, wherein the resin of a resin board and a resin-ceramic compound board is one of a thermal plastic high molecules material and thermal setting high molecules material.

5. The method for manufacturing microchip antenna as claimed in claim 3, wherein the dielectric substrate is formed be using a single layer of substrate or multiple layers of substrate with the same dielectric constant or various dielectric constants.

6. The method for manufacturing microchip antenna as claimed in claim 1, wherein the resin-ceramic compound material capable of fine-adjusting the dielectric constant thereof easily is processed into thermal plastic high molecular materials, or thermal setting high molecular materials, and ceramic powders or fiber with various components and ratios; the dielectric constant is adjusted by adjusting the components and ratios.

7. The method for manufacturing microchip antenna as claimed in claim 1, wherein the conductor loop is processed by the ways of exposure, development, etching, electroplating, non-electroplate, screen printing sintering, sputtering or printing so as to establish the conductor loop on a dielectric substrate with a specific dielectric constant.

8. The method for manufacturing microchip antenna as claimed in claim 1, wherein the dielectric substrate with the conductor paths is packaged by embedding type injection molding, two-material injection molding, mold-filling, screen thick firm printing, transfer printing or stacking so as to package dielectric material to a dielectric substrate with conductor paths.

9. The method for manufacturing microchip antenna as claimed in claim 1, wherein the packaging material and the dielectric substrate having antennal radiated conductor paths are packaged by the way of single surface packaging.

10. The method for manufacturing microchip antenna as claimed in claim 1, wherein the packaging material and the dielectric substrate having antennal radiated conductor paths thereon are packaged by way of double surface packaging.

11. The method for manufacturing microchip antenna as claimed in claim 1, wherein the packaging material and the dielectric substrate having antennal radiated conductor paths thereon are packaged by way of partial single surface packaging.

12. The method for manufacturing microchip antenna as claimed in claim 1, wherein the packaging material and the dielectric substrate having antennal radiated conductor paths thereon are packaged by way of partial double surface packaging.

13. The method for manufacturing microchip antenna as claimed in claim 1, wherein the packaging material is composed of at least two different materials.
